(19) United States
(12) Patent Application Publication
(10) Pub. No.: US 2022/0379873 A1
(43) Pub. Date: Dec. 1, 2022

(54) APPARATUS OF CONTROLLING MODE SWITCHING TRANSITIONS IN MULTI-COMBUSTION MODE INTERNAL COMBUSTION ENGINE WITH A HYBRID PROPULSION SYSTEM

(71) Applicant: Fang Shui, South Lyon, MI (US)

(72) Inventor: Fang Shui, South Lyon, MI (US)

(21) Appl. No.: 17/329,330

(22) Filed: May 25, 2021

(51) Int. Cl. B60W 20/40; F02B 11/00; B60W 10/06; F02D 41/00

(52) U.S. Cl. CPC B60W 20/40; F02B 11/00; B60W 10/06; F02D 41/0087; B60W 2510/06; B60W 2710/0644; B60W 10/26

(57) ABSTRACT

Engine combustion mode-switching transitions are controlled through a coordination control of an electric machine and a multi-combustion mode engine coupled to each other with a hybrid propulsion system by following predetermined combustion mode-switching strategies and control algorithms.

### SUMMARY OF THE INVENTION

A hybrid propulsion system including at least one electric machine, a set of battery and a multi-combustion mode engine can achieve engine combustion mode-switching transitions through effective coordination control of the electric machine and the engine when coupled each other mechanically to obtain required engine operating points at least during the required time. The complicated engine operation conditions for combustion node-switching can be simplified into limited easy-to-switch operating point, therefore the predetermined and carefully optimized combustion mode-switching strategies and control algorithms can be executed to achieve effective, reliable, stable, and practical switching transitions between different engine combustion modes for better fuel efficiency and lower emission.

### BACKGROUND OF THE INVENTION

As an important means of transportation, automobiles still use internal combustion engines as their power source. Due to the increasingly energy and environmental issues, the fuel efficiency and emissions of engine have attracted special attention. There are two main types of traditional internal combustion engines: spark ignition (SI) gasoline engines and compression ignition (CI) diesel engines, and their characteristics are well known.

Around year 2000, a new type of homogeneous charge compression ignition (HCCI) engine began to receive attention. Different from the combustion methods of the above two types of engines, this type of engine first forms an approximately uniform air-fuel mixture in the cylinder and then compresses it. When the temperature of the mixture reaches the autoignition temperature near the compression top dead center, all the mixture starts to burn almost at the same time. The time when the combustion starts is controlled by the time when the temperature of the mixture rises to the auto-ignition temperature, which is relatively difficult. However, HCCI has its advantages: this combustion does not rely on flame propagation compared with SI gasoline engines, so theoretically there is no requirement for the fuel concentration of the mixture. In low-load conditions, highly diluted air-fuel mixtures can be used for combustion, thereby improving the thermal efficiency of the engine, and reducing nitrogen oxide emissions; this combustion does not rely on the diffusion of fuel in the air compared with CI diesel engines, there is no excessively rich mixture zone, so theoretically no soot will be produced. The nitrogen oxide content in the exhaust gas will also be greatly reduced due to lean burn.

HCCI combustion can generally only be used in medium and low load conditions. This is because after the engine load and the fuel concentration of the mixture increase to a certain level, the combustion begins to be rough, which is close to the deflagration phenomenon of a gasoline engine. The control of the combustion time has also become very difficult, requiring precise control of the temperature of the mixture. At this time, it is required to switch to traditional combustion methods. In addition, when the engine is cold-started, due to the low engine body temperature and large heat transfer losses, only SI combustion is often used.

There are different technical approaches to achieve HCCI combustion control. A solution called Controlled Autoignition (CAI) is to change the opening and closing time of the intake and exhaust valves under low load conditions, so that the exhaust gas generated by combustion cannot be completely discharged, and it will remain in the cylinder as residual exhaust gas. The presence of a large amount of hot residual exhaust gas raises the temperature of the mixed gas in the cylinder, which can reach the autoignition temperature at the compression top dead center, and spontaneous combustion occurs.

Another solution called Optimized Kinetic Process (OKP) is to increase the compression ratio of the engine to about 15, and it uses the heat of exhaust gas and coolant to heat intake air and enter the cylinder together with the unheated intake air. By controlling the ratio of the two airflows, the intake air temperature can be quickly adjusted, thereby controlling the combustion time of HCCI. Bench tests have proved that this scheme can greatly reduce fuel consumption, and the working range of HCCI is also relatively wide, which can cover medium and low load conditions commonly used in automobile engines.

To expand the working range of HCCI to the high load, there has been a scheme of using spark assist to help realize HCCI. The solution is to raise the temperature of the air-fuel mixture to above the critical temperature that can be ignited and achieve flame propagation (still below the autoignition temperature), and then ignite it with a spark plug. The ignited mixture propagates through the flame to make more mixture participate in the combustion and release heat, causing the pressure and temperature in the cylinder to further increase, and the remaining unburned mixture reaches the auto-ignition temperature and spontaneous combustion occurs. This “ignition-induced homogeneous charge compression ignition” combustion mode can be used as a transition mode between the two combustion modes of HCCI and SI.

To reduce the minimum mixture temperature required for “ignition-induced homogeneous charge compression ignition” and to expand the temperature range of the mixture required for combustion control, the mixture near the spark plug can be locally enriched. For this reason, a small amount of fuel injection can be achieved during the compression cycle in the cylinder.

In addition, there are some other HCCI schemes, such as the use of variable compression ratios, the use of dual fuels, and so on.

Since the end of the last century, HCCI engines have been valued gradually. They have also achieved stable operation and can switch between different combustion modes on the engine test bench in laboratory. They have even been installed on cars for fleet trials. But they have not been applied in products so far, for many reasons. In addition to the problems in the technical approaches, there are also technical difficulties caused by the HCCI combustion itself.

First, unlike traditional engines, the combustion time of HCCI can only be controlled indirectly by adjusting the temperature of the air-fuel mixture near the top dead center of compression or the auto-ignition temperature of the fuel. For this reason, the intake air temperature control valve can be adjusted to control the intake air temperature, adjust the opening and closing time of the intake and exhaust valves to control the amount of residual exhaust gas, adjust the compression ratio of the engine, adjust the ratio of two fuels, and so on. Since the above-mentioned devices and operating parameters can only be controlled indirectly to control the combustion time of HCCI, the difficulty of control is increased.

Secondly, to make the operating range of this engine comparable to that of traditional engines, HCCI engines often use two or more combustion modes, such as HCCI, SI, and spark ignition to trigger homogeneous charge compression ignition or spark assisted compression ignition (SACI), traditional heterogeneous compression ignition, etc. Different combustion modes have different requirements for the adjustment of the control device. However, a working cycle of a vehicle engine at different speeds is approximately within a time range of 0.02 seconds to 0.15 seconds. It is difficult to quickly change the environment in the combustion chamber in such a short period of time to make it suitable for another combustion mode.

Because the control of HCCI is more complicated and difficult, for switching from the traditional combustion mode to the HCCI mode, it is necessary to carefully study the combustion mode-switching strategies and control algorithms in advance to understand clearly so that the control device can issue appropriate commands, let the engine control actuating devices adjust step by step. However, the number of engine operating points and engine thermal state before the mode switch are unlimited. Therefore, a careful study of all possible switching conditions in advance is too much work, which has become a major difficulty for the application of multi-combustion mode engines in automotive products.

Based on the above reasons, it is necessary to find an effective, reliable, stable, and practical engine combustion mode-switching strategies and control algorithms to realize the application of multi-combustion mode engine in automotive products.

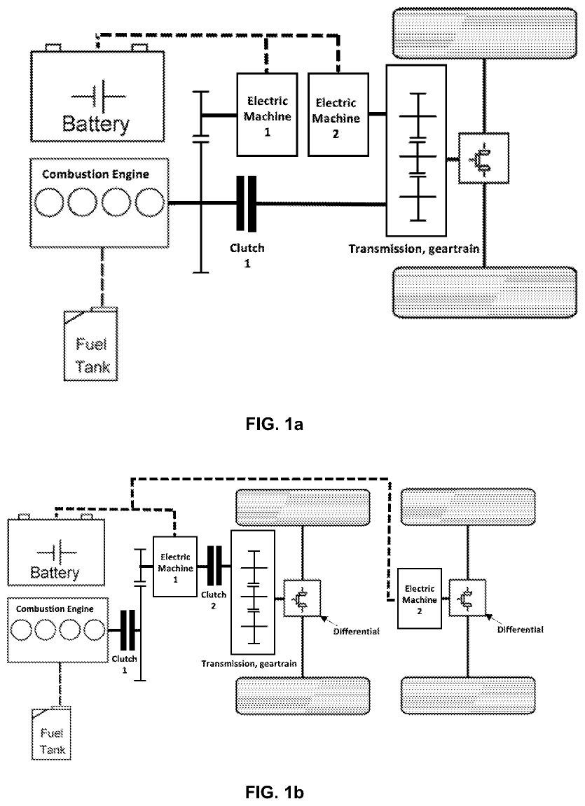

While the automotive internal combustion engine technology is constantly advancing, the technology for driving cars with electric motors and powertrain electrification is also constantly evolving. More than 20 years ago, hybrid vehicles began to appear on the market. This kind of car still uses the traditional engine as the power source, but its powertrain has integrated batteries and electric machines besides the transmission or geartrain. The electric machine can be a generator or motor, or with two functions in one. The battery is a device that can store energy from and supply energy to the electric machine. There are many different design configurations for hybrid systems as shown in FIG. 1, including, but not limited to:
a) Parallel configuration, the actual vehicle driving power demand can be provided by (i) engine alone. In FIG. 1a, when clutch 1 is engaged, only engine provides driving power to vehicle drive system. In FIG. 1b, when clutch 1 and clutch 2 are engaged, only engine provides driving power to vehicle drive system. In FIG. 1c, when clutch 1 is engaged, only engine provides driving power to vehicle drive system. In FIG. 1d, only engine provides driving power to vehicle drive system; (ii) both engine and electric machine. In FIG. 1a, when clutch 1 is engaged, both engine and electric machines 2 provide driving power to vehicle drive system. In FIG. 1b, when clutch 1 and clutch 2 are engaged, both engine and electric machines 1 and 2 provide driving power to vehicle drive system. In FIG. 1c, when clutch 1 is engaged, both engine and electric machines 1 and 2 provide driving power to vehicle drive system. In FIG. 1d, both engine and electric machine 2 provide driving power; (iii) electric machine alone. In FIG. 1a, when clutch 1 is disengaged, electric machine 2 provides driving power to vehicle drive system. In FIG. 1b, when clutch 1 is disengaged, electric machines 1 and 2 provide driving power to vehicle drive system. In FIG. 1c, when clutch 1 is disengaged, electric machine 2 provides driving power to vehicle drive system, n FIG. 1d, electric machine 2 provides driving power to vehicle drive system.
b) Series configuration, there is no direct mechanical connection between engine and vehicle drive system, it is called range extender sometimes, and the vehicle is driven by the electric machine alone, such as in FIG. 1a, when clutch 1 is disengaged or eliminated; in FIG. 1b, when clutch 2 is disengaged; in FIG. 1c, when clutch 1 is disengaged. The electricity required by electric machine 2 to drive vehicle can be provided by: (i) electric machine 1 (generator) driven by engine only; (ii) battery only; (iii) battery and electric machine 1 (generator) driven by engine together.
c) Parallel/Series configuration as shown in FIG. 1. The four different types of hybrid systems can realize both functions of parallel/series configurations, which can work in parallel or in series, selectively.

If the battery of the above-described hybrid systems cannot be charged externally, they will be a so-called hybrid electric vehicle (HEV). If battery of the above-described hybrid systems can be charged by external electric source and the electric machine of the above-described hybrid systems has sufficient power to drive vehicle, they will be a so-called plug-in hybrid electric vehicle (PHEV).

A vehicle using electric machine to drive has obvious advantages in response to vehicle driving power demand, such as high torque output at low-speed, smooth speed regulation, fast response time and high efficiency. Also, electric machine can better meet driver random demand to make large and rapid changes in output power based on road and traffic conditions.

Current (plug-in) hybrid electric vehicles mainly use SI gasoline engines and CI diesel engines. The development and improvement of new engine technology are also mainly focused on reducing fuel consumption and emissions and expanding the range of low fuel consumption operation. Its control strategy is mainly realized by using the electric machine as a motor/generator and the battery for energy storage and discharge, that is, through the motor/generator to regulate the engine operating point for entering the range of low fuel consumption operating conditions under only one combustion mode. The battery will supply electricity to the motor or absorb the electricity from generator including, but not limited to the energy recovery from the motor connected to vehicle drive system in regen mode during vehicle deceleration and brake, thereby improving engine fuel economy. In urban conditions, the fuel consumption of hybrid electric vehicles can be significantly lower than that of traditional engine vehicles. Plug-in hybrid electric vehicles (PHEV) have full-electric range (AER), so external electricity is used for driving vehicle, therefore fuel consumption is further reduced,

It is not ideal to use a SI gasoline engine because its fuel efficiency is always lower than that of a CI diesel engine. Although CI diesel engines can achieve higher fuel efficiency, their nitrogen oxides post-treatment is more difficult, and they have higher particulate matter (PM) emissions, and their cost and weight are also high, so their applications are limited.

Although the above-mentioned HCCI engine has great advantages in fuel consumption and emissions, but due to its combustion control and the difficulty of switching between combustion modes, and it has not yet been applied to (plug-in) hybrid electric vehicle products.

### DETAILED DESCRIPTION OF THE DRAWINGS

FIG. 1 is a group of schematic diagrams of hybrid propulsion system.

FIG. 1a is a schematic diagram of a hybrid propulsion system in A configuration.

FIG. 1b is a schematic diagram of a hybrid propulsion system in B configuration.

FIG. 1c is a schematic diagram of a hybrid propulsion system in C configuration.

FIG. 1d is a schematic diagram of a hybrid propulsion system in D configuration.

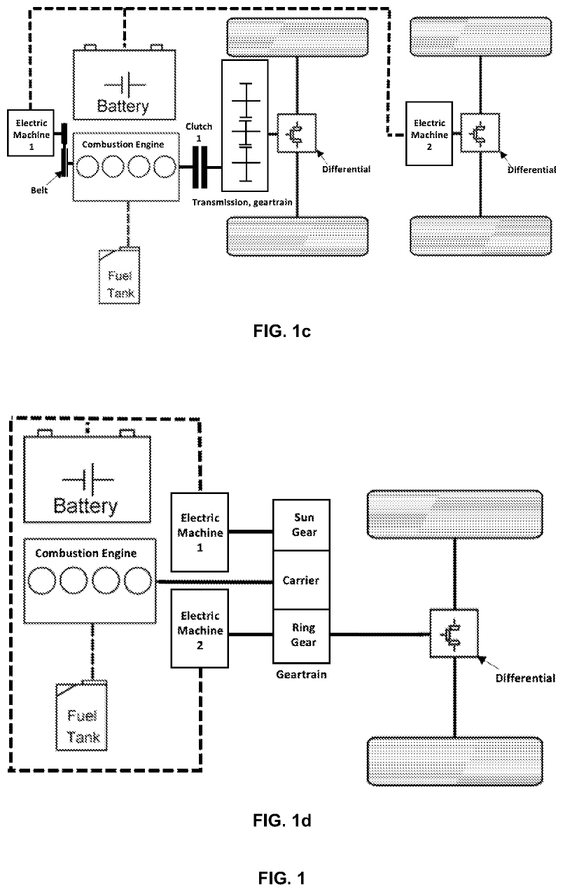

FIG. 2 is a group of schematic diagrams of an engine operating point.

FIG. 2a is a schematic diagram of an engine operating points in SI combustion mode.

FIG. 2b is a schematic diagram of an engine operating points in multi-combustion modes.

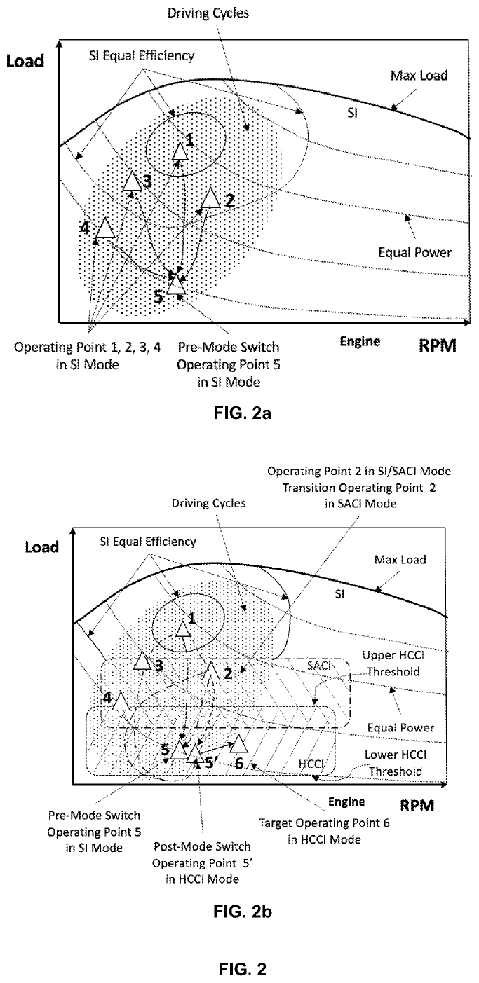

FIG. 3 is a schematic diagram of a vehicle driving power demand vs. output power of the hybrid propulsion system with a multi-combustion mode engine.

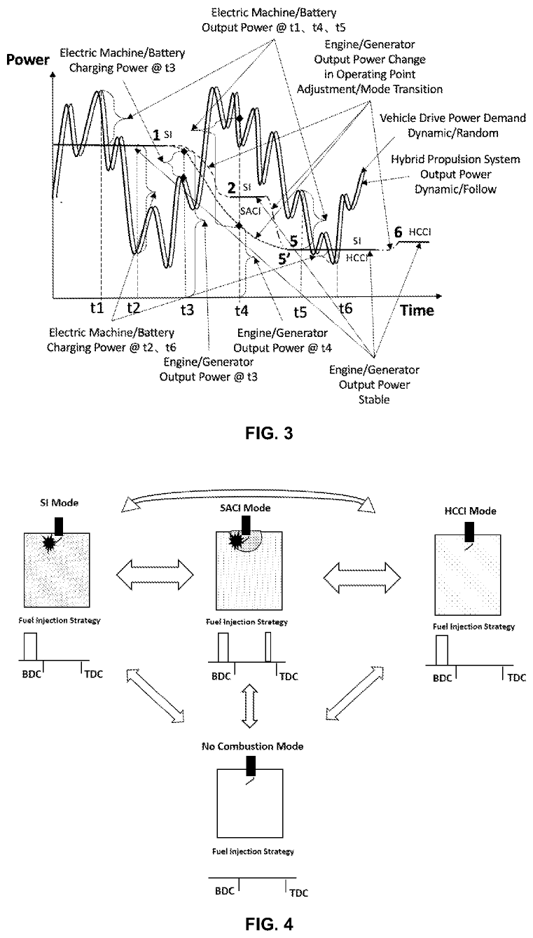

FIG. 4 is a schematic diagram of different control strategies and fuel supply strategies for the engine combustion mode-switching operation, and several combustion modes switching approaches.

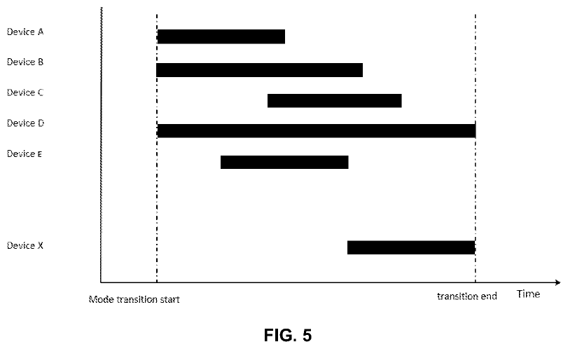

FIG. 5 is a schematic diagram of an engine with different control devices or actuators that have different start time and end time for adjustments.

### DETAILED DESCRIPTION OF THE INVENTION

The main goal of this invention is to apply a multi-combustion mode engine to a vehicle through integration of a vehicle hybrid propulsion system with coordination control strategies, combustion mode-switching strategies and control algorithms, so as to further reduce the fuel consumption and emissions of the vehicle, and ultimately reduce the comprehensive energy consumption (total fuel consumption and electric energy consumption) of the vehicle with the lowest and least impact on the environment.

HCCI technology has not been applied in automotive products for a long time, which has a lot to do with the complexity and difficulty of combustion control, especially the difficulty of switching from traditional combustion mode, such as SI mode to HCCI mode.

It has been recognized that a multi-combustion mode engine can not only work stably and reliably in various combustion modes, but also can change working conditions or switch combustion modes on an engine test bench equipped with an electric dynamometer in the laboratory.

Based on the above knowledge, the present invention proposes that a hybrid propulsion system including electric machine(s) a set of battery and a multi-combustion mode engine can (1) make full use of the inherent characteristics of hybrid propulsion system to achieve new synergies through innovative integration of hybrid propulsion system with effective coordination control of the electric machine and the engine, as well as the battery to obtain required engine operating points or required different combinations of engine rotational speed and load at least during the required time. Therefore, the complicated engine operation conditions for combustion mode-switching can be simplified into one or limited easy-to-switch operating point, which provides the condition for the combustion mode-switching operation; (2) through the innovative integration of hybrid propulsion system with effective coordination control strategy, the combustion mode-switching strategies and control algorithms can be carefully optimized in advance during system development process, then apply them to a vehicle with the proposed hybrid propulsion system as need. The present invention mainly revolves around the above two new ideas to achieve effective, reliable, stable, and practical switching transitions between different combustion modes:

First, the proposed hybrid propulsion system comprises at least one electric machine with both motor and generator modes, a set of battery for energy supply and absorption and a multi-combustion mode engine for output power. The electric machine rotational shaft can be coupled to the engine crankshaft mechanically or by other connecting methods at least during the required time for engine combustion mode-switching operation. A coordination controller based on the innovative coordination control strategy not only control the electric machine to drive and load the engine when both have been coupled each other, but also regulate fuel supply or air-fuel ratio of the engine for the engine operation control. The engine and the electric machine coupled to each other are operated and controlled coordinately to achieve the required engine operating points with different combinations of the engine rotational speed and load, which even includes but no limited to the engine having only rotational speed without torque output when fuel supply to the cylinders is stopped in order to meet combustion mode-switching operation conditions. The engine operation can be adjusted from any engine operating point (rotational speed and load) to a specified engine operating point (rotational speed and load) as the combustion mode-switching operation need as shown in FIG. 2a.

Secondly, the electric machine and the engine are coupled mechanically to adjust and maintain the required engine operating point and the state required for the combustion mode-switching operation as need. So, the predetermined and optimized combustion mode-switching strategies and control algorithms can be implemented during this time, which include some needing longer time for execution.

More important, during the combustion mode-switching operation, the present invention proposes that the engine output power including the engine rotational speed and torque does not need to follow the vehicle driving power demand closely under the action of the electric machine backed by the battery. Through coordination control of the electric machine and engine coupled each other, the operating point or the engine output power is “irrelevant” to vehicle driving power demand at least during the combustion mode-switching operation. Since the electric machine and the battery can absorb and compensate the difference between the engine output power and the vehicle driving power demand, so, only the total output power of the engine and the electric machine is needed to meet the vehicle driving power demand. Meanwhile, the engine operating points with difficult combustion mode-switching operation, such as from SI mode to HCCI mode-switching, can be avoided by controlling the engine operating points to occur only in one or limited pre-mode switch operating point or easy-to-switch operating point, which can be predetermined in advance during system development. Therefore, when implementing combustion mode-switching operation, it is proposed to change engine current operating points to one or limited pre-mode switch operating point under the same combustion mode. When the state of the engine operation meets the combustion mode switch conditions through implementation of the combustion mode-switching strategies and control algorithms, the mode-switching starts from the pre-mode switch operating point under current combustion mode to post-mode switch operating point under the new combustion mode. It is possible to add one or more intermediate transition combustion modes as need, such as SACI. After mode-switching, the engine operating point can be re-adjusted to target operating point or other operating points as need under the new combustion mode as shown in FIG. 2b.

During the combustion mode-switching transition, the engine operation maybe abnormal, such as the gas work fluctuation in the cylinder, which could cause the engine output power including the engine rotational speed and torque unstable, fluctuation or even interruption. However, through the coordination control of the electric machine and the engine, the electric machine and the battery can absorb, compensate and suppress those fluctuation or even interruption to maintain required combustion mode switching operation conditions. Therefore, the present invention not only ensure the smooth combustion mode-switching transition but also ensure the total output power of the engine and the electric machine and any additional electric machine(s) connected to the vehicle drive system if adopted in the proposed hybrid propulsion system meet the vehicle driving power demand.

In addition, the engine can be controlled in some efficient and stable operating region or limited operating point to avoid some operating regions or threshold where the combustion and emission control are difficult. For example, when the engine operating points under HCCI combustion mode is dose to the upper or the lower threshold of its operating range, such as the overlap area of SACI and HCCI as shown in FIG. 2b, the control of combustion and post-treatment of emission become difficult.

Due to the limited number of predetermined and easy-to-switch operating points, it is possible to select one or limited engine operating point, at least one operating point that is required in advance during the system development, and carefully optimize the combustion mode-switching strategies and control algorithms. For example, it includes but not limited to the development of multiple set of control instructions to perform a sequence adjustments of the engine control devices or actuators selectively for how to deal with slight deviation in the mode-switching conditions or engine thermal conditions during switching the combustion mode. After completing the combustion mode-switching operation, the engine will be operated under the new combustion mode. The invention is further descried as:
1) The present invention proposes when the engine and the electric machine coupled each other, which includes but not limited to the electric machine rotating shaft connected to the engine crankshaft mechanically or by other connecting methods, the operating points including rotational speed and load of the electric machine and the engine are controlled coordinately. Therefore, the engine operation can follow the predetermined path from current operating point to the easy-to-switch operating point through the coordination control. According to the engine operation status including, but not limited to thermal status, the engine controller can control one, multiple, and all of the engine control devices or actuators and the operating parameters by following the predetermined combustion mode-switching strategies and control algorithms as need in certain time period including, but not limited to adjusting the fuel supply of the engine, fuel supply strategy, intake air temperature, intake pressure, residual exhaust gas volume, air-fuel ratio, valve timing, ignition time, effective or geometric compression ratio, etc.
2) Because of the easy-to-switch operating point that can be one or a limited number, it is feasible in advance during the system development to find out what the control devices or actuators and the operating state parameters can be adjusted and how to be adjusted when the engine working conditions change between the engine operating points. Also, in different external environment and engine thermal status under different combustion mode, it is feasible to find out and optimize the combustion mode-switching strategies and control algorithms for the different engine combustion mode-switching condition application.
3) The present invention further proposes when adjusting engine operating point under a certain combustion mode, the electric machine and the engine are operating coordinately from one operating point to another operating point through the coordination control. For example, the engine operation is adjusted from operating point 1, 2, 3, 4 respectively to one or limited easy-to-switch operating point 5, which could be called pre-mode switch operating point as shown in FIG. 2a.
4) In FIG. 1a, when clutch 1 is engaged, electric machine 1 and the engine are controlled coordinately during combustion mode-switching operation, electric machine 1 can control the coupled engine abnormal operation by driving or loading the engine through the coordination control to adjust, meet, and maintain the state of the combustion mode-switching operation as need, electric machine 1 can absorb or compensate the coupled engine output power variation to meet the vehicle driving power demand. Electric machine 2 connected to vehicle drive system and electric machine 1 coupled to the engine jointly meet vehicle driving power demand. The vehicle speed control can be achieved through the control of electric machine 2 and the transmission or gearing coordinately.
5) When clutch 1 and clutch 2 are engaged in FIG. 1b and clutch 1 is engaged in FIG. 1c, electric machine 1 and the engine are controlled coordinately during combustion mode-switching operation, electric machine 1 can control the coupled engine abnormal operation by driving or loading the engine through the coordination control to adjust, meet, and maintain the state of the combustion mode-switching operation as need. Electric machine 2 is connected to the vehicle drive system to share the load of electric machine 1 and the engine through the coordination control and jointly meet the vehicle driving power demand as need. The vehicle speed control can be achieved through the control of electric machine 2 and the transmission or gearing coordinately.
6) If clutch 1 is disengaged in FIG. 1a, dutch 2 is disengaged in FIG. 1b, and dutch 1 is disengaged in FIG. 1c, electric machine 2 provides driving power for the vehicle alone and controls the speed of the vehicle. The required electricity of electric machine 2 can be provided by the battery and electric machine 1 driven by the engine together or respectively during combustion mode-switching operation. Electric machine 1 can control the coupled engine abnormal operation by driving or loading the engine through the coordination control to adjust, meet, and maintain the state of the combustion mode-switching operation as need. The output electricity variation, fluctuation or even interruption of electric machine 1 driven by the engine during the combustion mode-switching operation will be absorbed and compensated by the battery.
7) In FIG. 1d, electric machine 1 is coupled to the engine by geartrain and electric machine 1 can control the coupled engine abnormal operation by driving or loading the engine through the coordination control to adjust, meet, and maintain the state of the combustion mode-switching operation as need. Electric machine 2 is connected to the vehicle drive system by the geartrain to share the load of electric machine 1 and the engine through the coordination control and jointly meet the vehicle driving power demand as need. The vehicle speed control can be achieved through the control of electric machine 2, electric machine 1 and the engine coordinately.
8) FIG. 2b and FIG. 3 further describe how the coordination control strategy of the electric machine and the multi-combustion mode engine proposed by the present invention realizes the engine operation in different combustion modes and the combustion mode-switching operation in the hybrid propulsion system:
   when engine or generator (engine-driven electric machine) output power is less than vehicle driving power demand, electric machine(s) connected to vehicle drive system and the battery will compensate vehicle driving power demand. This system operation is depicted as operating point 1 with SI mode at time t1, operating point 5 with SI mode/operating point 5′ with HCCI mode at time t5, operating point 2 with SI or SACI mode/mode-switching transition at time t4.
   when the engine or generator (engine-driven electric machine) output power is more than vehicle driving power demand, the electric machine(s) connected to vehicle drive system and the battery will absorb the excessive output power of engine or generator. This system operation is depicted as operating point 1 with SI mode at time t2, operating point 5 with SI mode/operating point 5′ with HCCI mode at time t6, operating point adjustment from to 2 or 5 with SI mode/mode-switching transition at time t3.
9) FIG. 4 illustrates different control strategies and fuel supply strategies of the engine combustion mode-switching operation, and at least but not limited to several combustion mode-switching sequences:
   i. Switch from SI to HCCI:
      switch from operating point 1 with SI mode to operating point 2 with SACI mode, if need, further to operating point 5′ with HCCI mode, finally to target operating point 6 with HCCI.
      adjust from operating point 1 or 2 with SI mode to pre-mode switch operating point 5 with SI mode, then switch to post-switch mode operating point 5′ with HCCI mode, finally to target operating point 6 with HCCI mode.
      switch from operating point 1 or 2 with SI mode to operating point 5′ directly, then to target operating point 6 with HCCI mode.
      during combustion mode-switching transition, it is possible to add no combustion mode as need.
   ii. Switch from HCCI to SI:
      switch from HCCI to SI directly.
      switch from HCCI to SACI first, then to SI.
      during combustion mode-switching transition, it is possible to add no combustion mode as need.

After the combustion mode is switched or the transition is completed, the engine will be operated under the new combustion mode.
10) The present invention also proposes that engine operation conditions can be controlled in a stable and higher efficient operating region or limited operating points under one combustion mode, such as HCCI mode. Therefore, the output power of the engine may be greater or less than the vehicle driving power demand, the difference can be absorbed or compensated by the battery in order to reduce the combustion mode-switching frequency.

If the state of charge (SOC) of the battery is lower than a certain value, the engine output power under a certain combustion mode can be controlled to be greater than the vehicle driving power demand. The battery in charging mode will absorb the excessive electricity from the engine.

If the state of charge (SOC) of the battery is higher than a certain value, the engine output power in a certain combustion mode can be controlled to be lower than the vehicle driving power demand or even the engine can stop running, so the battery is in discharging mode to supply electricity to electric machine for drive. It also does not rule out the use of control methods in which the engine output power follows the dynamic and random vehicle driving power demand in a certain combustion mode.
11) During the combustion mode-switching operation, it takes time to adjust multiple engine control devices or actuators. FIG. 5 is a schematic diagram of an engine with different control devices or actuators that have different start time and end time with adjustments. For example, the start time (crankshaft phase) with adjustment of each control device or actuator and operating parameter can be different. The length of adjustment (the angle of crankshaft rotation) can also be different. Also, when switching from SI mode to HCCI mode, if HCCI combustion mode is used immediately in the next working cycle, the high temperature of mixture air that may be caused by the high temperature of residual exhaust gas in the cylinder due to the high temperature of SI combustion gas, will be not conducive to the control of HCCI combustion. On the other hand, the intake air temperature for SI mode is low and HCCI mode requires a higher intake air temperature. If the intake air temperature is adjusted by the intake air temperature control valve, there will be a lag in the increase of the intake air temperature, which could cause the mixed air temperature of the first HCCI cycle to be too low. So, it is not conducive to the combustion time control also. In this case, it is difficult to control the temperature of the mixture at the end of compression. The present invention proposes that the intake air temperature control valve can be adjusted immediately after the last SI combustion cycle and the intake air is regulated to meet the temperature required by the new combustion mode. At the same time, fuel supply can be stopped for the next working cycle until the intake air temperature reaching the required condition and being stabilized, then fuel supply resume for HCCI combustion mode as shown in FIG. 4.
12) For a multi-cylinder and multi-combustion mode engine, the phase of each cylinder is different at any instant, so when switching the combustion mode, it is difficult to make each cylinder adjust each control device or actuator at the best time, which increases the difficulty of switching the combustion mode. In addition to some control devices that control the overall parameters of the multi-cylinder engine, such as throttle valves, there are also some control devices or actuators that can individually control each cylinder including, but not limited to the cylinder gas temperature control device, ignition time, fuel injection time and quantities, etc. The control strategy proposed by the present invention include that the same or different combustion mode-switching strategies and control algorithms can be used for different cylinders. The switching can start from a pre-determined crankshaft phase, and the electric machine can control the operating conditions of the coupled engine coordinately, such as engine rotational speed and load, and the control device or actuator of the whole engine and each cylinder can be controlled in an orderly manner. Each cylinder can go through a different switching operation, for example, some cylinders can switch the combustion mode directly and others can switch to an intermediate transition combustion mode first. As shown in FIG. 2b (the figure only for concept illustration), at same crankshaft rotational speed, the different cylinder pressure may be different due to in different combustion mode transition: one cylinder switches from operating point 1 to pre-mode switch operating point 5 in SI mode, then to target operating point 6 in HCCI mode, other cylinders switch from operating point 1 with SI mode to operating point 2 with intermediate SACI mode, then to post-mode switch operating point 5′ with HCCI mode, finally to targe operating point 6 with HCCI mode, etc.
13) The principle of the present invention can also be applied to a rotary engine or a free piston engine with linear generator.

From the foregoing, it can be seen that there has been brought to the art a new multi-combustion mode engine with hybrid propulsion system which has the advantages of a smooth combustion mode-switching operation when transitioning between the different combustion modes. While the invention has been described in connection with one or more embodiments, it should be understood that the invention is not limited to those embodiments. On the contrary, the invention covers all alternatives, modifications, and equivalents as maybe included within the spirit and scope of the appended claims.

1. A hybrid propulsion system producing output power to drive a vehicle, comprising:
an engine having at least one combustion cylinder operatable selectively in one or more combustion modes, wherein the first combustion mode is a spark ignition mode, the second combustion mode is a compression auto-ignition mode, and the third combustion, if adopted, is a spark assisted compression ignition mode or other types of combustion modes as an intermediate combustion mode, wherein the engine is configured to supply output power; and
a controller configured to control the engine operation at least in one of the multi-combustion modes selectively in the combustion mode-switching operation, besides the control of the engine operation under one combustion mode for the vehicle normal (plug-in) hybrid operation; and
an electric machine having both motor for drive and generator for absorption modes, is coupled to the engine mechanically through the electric machine rotational shaft and the engine crankshaft or by other mechanical connecting methods to drive or load the engine to realize the control of the engine operating points to achieve different combination of the engine rotational speed and load at least during the combustion mode-switching operation through a coordination control, the electric machine can absorb and compensate at least a portion of the difference between the engine output power and the vehicle driving power demand during the combustion mode-switching operation; and
a controller configured to control the electric machine to operate in either the motor mode or the generator mode selectively during combustion mode switching operation, besides the control of the electric machine for the vehicle normal (plug-in) hybrid operation; and
an additional electric machine or more additional electric machines can be adopted as need, wherein the additional electric machine(s) can be connected to the vehicle drive system to provide driving power for the vehicle or share at least a portion of the load of the electric machine and the engine during the combustion mode-switching operation through a coordination control as need; and
a controller configured to control the additional electric machine(s) operation during combustion mode switching operation if adopted, besides the control of the additional electric machine(s) for the vehicle normal (plug-in) hybrid operation; and
a set of battery having both charging or discharging electricity modes can supply at least a portion of electricity to or store at least a portion of electricity from the electric machine and the additional electric machine(s) if adopted during the combustion mode-switching operation through a coordination control; and
a controller configured to control the battery to operate in either charging mode or discharging mode selectively for the electric machine and the additional electric machine(s) if adopted during the combustion mode switching operation, besides the control of the battery for the vehicle normal (plug-in) hybrid operation.

2. The system according to claim 1, further comprising:
a coordination controller in operative communication with each controller of the engine, the electric machine, and the additional electric machine(s) connected to the vehicle drive system if adopted, and the battery configured to control the engine, the electric machine, and the additional electric machine(s) if adopted, and the battery coordinately during the combustion mode-switching operation, besides the control of those elements for the vehicle normal (plug-in) hybrid operation; and
the coordination controller controls one, multiple, or all of the parameters including, but not limited to electric voltage, current, frequency of the electric machine and the additional electric machine(s) if adopted and one, multiple, or all of parameters including, but not limited to fuel supply quantities, air-fuel ratio of the engine to drive or load the engine under the action of the coupled electric machine to realize the control of the engine operating points having the different combinations of the rotational speed and the load; and
through the coordination control, whereby the operation of the engine under the action of the coupled electric machine can be controlled in required operating region or limited operating points with high thermal efficiency and low emission combustion modes and to avoid some regions or threshold of some combustion modes where it is difficult to control combustion and emission; and
through the coordination control, whereby the combustion mode-switching operation of the engine under the action of the coupled electric machine can be controlled by regulating the engine operation from current any operating points to one or limited predetermined pre-mode switch or easy-to-switch operating point(s) under current combustion mode following predetermined path comprising different predetermined combinations of one or limited pair of the engine rotational speed and load; and
through the coordination control, whereby the engine under the action of the coupled electric machine is operated at one or limited predetermined pre-mode switch or easy-to-switch operating point(s) that the engine rotational speed is independent of the vehicle speed; and
through the coordination control, whereby the engine under the action of the coupled electric machine is operated at one or limited predetermined pre-mode switch or easy-to-switch operating point(s) to adjust, meet, and maintain the state of the combustion mode-switching operation as need.

3. The system according to claim 2, wherein the hybrid propulsion system is further configured as:
the engine and the electric machine are coupled, and both the engine and the electric machine are connected to the vehicle drive system for vehicle driving at same time or respectively to meet at least a portion of the vehicle driving power demand during the combustion mode-switching operation; and
the engine operation can be unstable, fluctuation or even interruption during the combustion mode-switching operation, the electric machine can control the coupled engine abnormal operation by driving or loading the engine through the coordination control to adjust, meet, and maintain the state of the combustion mode-switching operation as need, the electric machine can absorb or compensate the variation of the coupled engine output power to meet the vehicle driving power demand; and
the additional electric machine(s) if adopted is connected to the vehicle drive system to share at least portion of the load of the electric machine and the engine through the coordination control and jointly supply driving power to meet the vehicle driving power demand as need during the combustion mode-switching operation; and
the vehicle speed control can be achieved through the control of the transmission or geartrain and the additional electric machine(s) if adopted coordinately during the combustion mode-switching operation.

4. The system according to claim 2, wherein the hybrid propulsion system is further configured as:
the engine and the electric machine are coupled, and both the engine and the electric machine are not connected to the vehicle drive system for vehicle driving, the electric machine and the battery provide electricity to the additional electric machine(s) at same time or selectively to drive the vehicle alone to meet the vehicle driving power demand during the combustion mode-switching operation; and
the engine operation can be unstable, fluctuation or even interruption during the combustion mode-switching operation, the electric machine can control the engine abnormal operation by driving or loading the engine through the coordination control to adjust, meet, and maintain the state of the combustion mode-switching operation as need, the output electricity variation of the electric machine due to the engine unstable output power can be absorbed or compensated at least partially by the battery through the coordination control during the combustion mode-switching operation to meet vehicle driving demand; and
the vehicle speed control can be achieved through the control of the additional electric machine(s) connected to the vehicle drive system alone during the combustion mode-switching operation.

5. The system according to claim 2, wherein the hybrid propulsion system is further configured as:
the engine and the electric machine are coupled, and both the engine and the electric machine can be connected and disconnected to the vehicle drive system for vehicle driving selectively and the additional electric machine(s) is connected to the vehicle drive system for driving the vehicle; and
when both the engine and the electric machine are connected to the vehicle drive system, the engine operation can be unstable, fluctuation or even interruption during the combustion mode-switching operation, the electric machine can control the engine abnormal operation by driving and loading the engine through the coordination control to adjust, meet, and maintain the state of the combustion mode-switching operation as need; and
the electric machine can absorb and compensate the engine output power variation to meet the vehicle driving power demand alone or the additional electric machine(s) can share at least portion of the load of the electric machine and the engine through the coordination control and jointly drive the vehicle to meet the vehicle driving power demand as need during the combustion mode-switching operation; and
the vehicle speed control can be achieved through the control of the transmission or geartrain and the additional electric machine(s) coordinately during the combustion mode-switching operation; and
when both the engine and the electric machine are not connected to the vehicle drive system, the electric machine and the battery provide electricity to the additional electric machine(s) at same time and selectively to drive the vehicle alone to meet the vehicle driving power demand during the combustion mode-switching operation; and
the engine operation can be unstable, fluctuation and even interruption during the combustion mode-switching operation, the electric machine can control the engine abnormal operation by driving and loading the engine through the coordination control to adjust, meet, and maintain the state of the combustion mode-switching operation as need; and
the output electricity variation of the electric machine due to the engine unstable output power can be absorbed and compensated at least partially by the battery through the coordination control during the combustion mode-switching operation; and
the vehicle speed control can be achieved through the control of the transmission or geartrain and the additional electric machine(s) coordinately during the combustion mode-switching operation.

6. The system according to claim 3, wherein when the engine is operated at the predetermined pre-mode switch or easy-to-switch operating point(s), the combustion mode-switching operation is implemented by following combustion mode-switching strategies and control algorithms in order of need with different combination and order to adjust the engine control device or actuators and the parameters, comprising:
the adjustment of one, multiple and all of engine control devices or actuators and operating parameters including, but not limited to fuel supply quantities to each cylinder for each cycle, fuel supply strategies, intake air temperature, intake air pressure, residue exhaust gas volume, air-fuel ratio, intake/exhaust valve timings and lifts, spark ignition timing, effective or geometric compression ratios, etc. as required; and
the adjustment of the control devices or actuators for a multi-cylinder engine and each cylinder, starting from a pre-determined crankshaft phase in an orderly manner including, but not limited to the engine throttle valves, cylinder gas temperature control device, ignition time, fuel injection time and quantities, etc.; and
the adjustment of each cylinder can go through same or different mode-switching strategy and control algorithm, depending on the phase of each cylinder related to the crankshaft angle at the time when mode-switching start, some cylinders can switch the combustion mode directly from the current mode to the targeted mode and others can switch from the current mode to an intermediate transition combustion mode first, then to the targeted mode; and
the direct switching from the first combustion mode said the spark ignition mode to the second combustion mode said the compression auto-ignition mode as targeted mode or from the first combustion mode said the spark ignition mode to the third combustion mode said the spark-assisted compression ignition mode as targeted mode; and
the indirect switching from the first combustion mode said the spark ignition mode to the third combustion mode said the spark-assisted compression ignition mode as an intermediate transition combustion mode, then to the second combustion mode said the compression auto-ignition mode as targeted mode; and
the direct switching from the second combustion mode said the compression auto-ignition mode to the first combustion mode said the spark ignition mode as targeted mode or from the third combustion mode said the spark-assisted compression ignition mode to the first combustion mode said the spark ignition mode as targeted mode or from the second combustion mode said the compression auto-ignition mode to the third combustion mode said the spark-assisted compression ignition mode as targeted mode; and
the indirect switching from the second combustion mode said the compression auto-ignition mode to the third combustion mode said the spark-assisted compression ignition mode as an intermediate transition combustion mode, then to the first combustion mode said the spark ignition mode; and
the adjustment of the engine mode-switching operation condition in an orderly manner from the first or consecutive working cycles of the engine after starting combustion mode-switching operation including, but not limited to intake air temperature control valve adjustment immediately after the last combustion cycle and the intake air is regulated to meet the required temperature; and
the fuel supply to the cylinder can be stopped at the same time for the next working cycle until the intake air temperature reaching the required level and being stabilized; and
the fuel supply resume to start the following engine working cycles under the intermediate or targeted combustion mode when the state of the engine cylinder is adjusted to be suitable for the mode-switching; and
the engine is operated at post-mode switch operating point or targeted operating point under the targeted combustion mode; and
the engine can be operated and adjusted in the targeted combustion mode operating region as need.

7. The system according to claim 4, wherein when the engine is operated at the predetermined pre-mode switch or easy-to-switch operating point(s), the combustion mode-switching operation is implemented by following combustion mode-switching strategies and control algorithms in order of need with different combination and order to adjust the engine control device or actuators and the parameters, comprising:
the adjustment of one, multiple and all of engine control devices or actuators and operating parameters including, but not limited to fuel supply quantities to each cylinder for each cycle, fuel supply strategies, intake air temperature, intake air pressure, residue exhaust gas volume, air-fuel ratio, intake/exhaust valve timings and lifts, spark ignition timing, effective or geometric compression ratios, etc. as required; and
the adjustment of the control devices or actuators for a multi-cylinder engine and each cylinder, starting from a pre-determined crankshaft phase in an orderly manner including, but not limited to the engine throttle valves, cylinder gas temperature control device, ignition time, fuel injection time and quantities, etc.; and
the adjustment of each cylinder can go through same or different mode-switching strategy and control algorithm, depending on the phase of each cylinder related to the crankshaft angle at the time when mode-switching start, some cylinders can switch the combustion mode directly from the current mode to the targeted mode and others can switch from current mode to an intermediate transition combustion mode first, then to the targeted mode; and
the direct switching from the first combustion mode said the spark ignition mode to the second combustion mode said the compression auto-ignition mode or from the first combustion mode said the spark ignition mode to the third combustion mode said the spark-assisted compression ignition mode; and
the indirect switching from the first combustion mode said the spark ignition mode to the third combustion mode said the spark-assisted compression ignition mode as an intermediate transition combustion mode, then to the second combustion mode said the compression auto-ignition mode; and
the direct switching from the second combustion mode said the compression auto-ignition mode to the first combustion mode said the spark ignition mode or from the third combustion mode said the spark-assisted compression ignition mode to the first combustion mode said the spark ignition mode; and
the indirect switching from the second combustion mode said the compression auto-ignition mode to the third combustion mode said the spark-assisted compression ignition mode as an intermediate transition combustion mode, then to the first combustion mode said the spark ignition mode; and
the adjustment of the engine mode-switching operation condition in an orderly manner from the first or consecutive working cycles of the engine after starting combustion mode-switching including, but not limited to intake air temperature control valve adjustment immediately after the last combustion cycle and the intake air is regulated to meet the required temperature; and
the fuel supply to the cylinder can be stopped at the same time for the next working cycle until the intake air temperature reaching the required level and being stabilized; and
the fuel supply resume to start the following engine working cycles under the intermediate or targeted combustion mode when the state of the engine cylinder is adjusted to be suitable for the mode-switching; and
the engine is operated at post-mode switch operating point or targeted operating point under the targeted combustion mode; and
the engine can be operated and adjusted in the targeted combustion mode operating region as need.

8. The system according to claim 5, wherein when the engine is operated at the predetermined pre-mode switch or easy-to-switch operating point(s), the combustion mode-switching operation is implemented by following combustion mode-switching strategies and control algorithms in order of need to adjust engine control device or actuators and parameters, comprising:
the adjustment of one, multiple and all of engine control devices or actuators and operating parameters including, but not limited to fuel supply quantities to each cylinder for each cycle, fuel supply strategies, intake air temperature, intake air pressure, residue exhaust gas volume, air-fuel ratio, intake/exhaust valve timings and lifts, spark ignition timing, effective or geometric compression ratios, etc. as required; and
the adjustment of control devices or actuators for a multi-cylinder engine and each cylinder, starting from a pre-determined crankshaft phase in an orderly manner including, but not limited to the engine throttle valves, cylinder gas temperature control device, ignition time, fuel injection time and quantities, etc.; and
the adjustment of each cylinder can go through same or different mode-switching strategy and control algorithm, depending on the phase of each cylinder related to crankshaft angle at the time when mode-switching start, some cylinders can switch combustion mode directly from current mode to targeted mode and others can switch from current mode to an intermediate transition combustion mode first, then to targeted mode; and
the direct switching from first combustion mode said spark ignition mode to second combustion mode said compression auto-ignition mode or from first combustion mode said spark ignition mode to third combustion mode said spark-assisted compression ignition mode; and
the indirect switching from first combustion mode said spark ignition mode to third combustion mode said spark-assisted compression ignition mode as an intermediate transition combustion mode, then to second combustion mode said compression auto-ignition mode; and
the direct switching from second combustion mode said compression auto-ignition mode to first combustion mode said spark ignition mode or from third combustion mode said spark-assisted compression ignition mode to first combustion mode said spark ignition mode; and
the indirect switching from second combustion mode said compression auto-ignition mode to third combustion mode said spark-assisted compression ignition mode as an intermediate transition combustion mode, then to first combustion mode said spark ignition mode; and
the adjustment of the engine mode-switching operation condition in an orderly manner from first or consecutive working cycles of the engine after starting combustion mode-switching operation including, but not limited to intake air temperature control valve adjustment immediately after last combustion cycle and intake air is regulated to meet required temperature; and
the fuel supply to cylinder can be stopped at same time for next working cycle until intake air temperature reaching required level and being stabilized; and
the fuel supply resume to start the following engine working cycles under the intermediate or targeted combustion mode when the state of the engine cylinder is adjusted to be suitable for the mode-switching; and
the engine is operated at post-mode switch operating point or targeted operating point under the targeted combustion mode; and
the engine can be operated and adjusted in the targeted combustion mode operating region as need.
